(19) United States
(12) Patent Application Publication
(10) Pub. No.: US 2016/0295548 A1
(43) Pub. Date: Oct. 6, 2016

(54) Apparatus for Controlling Message Receiving Mode and Method Thereof

(71) Applicant: Hyundai Motor Company, Seoul (KR)

(72) Inventor: Yun Joong PARK, Seoul (KR)

(73) Assignee: Hyundai Motor Company

(21) Appl. No.: 14/919,250

(22) Filed: Oct. 21, 2015

(30) Foreign Application Priority Data
Apr. 3, 2015 (KR) 10-2015-0047238

(51) Int. Cl. H04W 68/00; H04W 4/02

(52) U.S. Cl. CPC H04W 68/005; H04W 4/02

(57) ABSTRACT

An apparatus for controlling a message receiving mode of a telematics terminal to which quick paging is applied includes a message receiver configured to receive a message from a telematics service center, an RSSI detector configured to detect an RSSI from a message received by the message receiver, a signal to noise ratio detector configured to detect a signal to noise ratio from the message received by the message receiver, and a controller configured to block the telematics terminal from entering into a sleep mode when the RSSI detected by the RSSI detector is equal to or less than a first threshold value and the signal to noise ratio detected by the signal to noise ratio detector is equal to or less than a second threshold value.

### CROSS-REFERENCE TO RELATED APPLICATION

This application claims the benefit of priority to Korean Patent Application No. 10-2015-0047238, filed on Apr. 3, 2015, the disclosure of which is incorporated herein in its entirety by reference.

### TECHNICAL FIELD

The present disclosure relates to an apparatus for controlling a message receiving mode and a method thereof, and more particularly, to a technology of enhancing a message receiving rate by blocking an entry into a sleep mode when a telematics terminal to which a quick paging system is applied is located in a weak electric field area.

### BACKGROUND

The statements in this section merely provide background information related to the present disclosure and may not constitute prior art.

Telematics is a compound word of telecommunication with informatics and means wireless data services which may transmit and receive information by an information processing apparatus embedded in transportation equipment such as a vehicle, aircraft, and a ship, a radio communication technology, a global positioning system (GPS), a technology of converting a character signal and an audio signal in the Internet, etc.

In particular, a telematics service for a vehicle provides vehicle accidents or stolen detection, a driving route guide, traffic and life information, game, etc., to a driver in real time by applying a mobile communication technology and a location tracking technology to a vehicle.

Further, the telematics terminal for a vehicle may call a service center in radio communication when a failure occurs while a vehicle is driving, receive an e-mail or provide road information through a display apparatus installed in front of a driving seat, provide a computer game through a display apparatus installed at back seats of a vehicle, and provide an accurate failure position and failure cause to a mechanic anytime since a controller connected to an engine of the vehicle records a state of main components of the vehicle.

Generally, the telematics terminal is applied with a quick paging system to enhance a call waiting time.

However, the quick paging system may normally receive a message while reducing power consumption in a standby mode when the telematics terminal is located in a strong electric field area but may have a reduced message receiving rate in a weak electric field area.

### SUMMARY

The present disclosure has been made to address the above-mentioned problems occurring in the prior art while advantages achieved by the prior art are maintained intact.

An aspect of the present disclosure provides an apparatus for controlling a message receiving mode and a method thereof capable of enhancing a message receiving rate from a telematics service center even in a weak electric field area, by permitting an entry into a sleep mode when a telematics terminal to which a quick paging system is applied is located in a strong electric field area and blocking an entry into the sleep mode when the telematics terminal is located in a weak electric field area to keep an active mode.

The foregoing and other objects, features, aspects and advantages of the present disclosure will be understood and become more apparent from the following detailed description of the present disclosure. Also, it can be easily understood that the objects and advantages of the present disclosure can be realized by the units and combinations thereof recited in the claims.

According to an exemplary form of the present disclosure, an apparatus for controlling a message receiving mode of a telematics terminal to which quick paging is applied includes: a message receiver configured to receive a message from a telematics service center; a received signal strength indicator (RSSI) detector configured to detect an RSSI from the message received by the message receiver; a signal to noise ratio detector configured to detect a signal to noise ratio from the message received by the message receiver; and a controller configured to block an entry into a sleep mode when the RSSI detected by the RSSI detector is equal to or less than a first threshold value and the signal to noise ratio detected by the signal to noise ratio detector is equal to or less than a second threshold value.

According to another exemplary form of the present disclosure, a method for controlling a message receiving mode of a telematics terminal to which quick paging is applied includes: receiving, by a message receiver, a message from a telematics service center; detecting, by an RSSI detector, the RSSI from the received message; detecting, by a signal to noise ratio detector, a signal to noise ratio from the received message; and blocking, by a controller, an entry into a sleep mode when the detected RSSI is equal to or less than a first threshold value and the detected signal to noise ratio is equal to or less than a second threshold value.

Further areas of applicability will become apparent from the description provided herein. It should be understood that the description and specific examples are intended for purposes of illustration only and are not intended to limit the scope of the present disclosure.

### DRAWINGS

The above and other objects, features and advantages of the present disclosure will be more apparent from the following detailed description taken in conjunction with the accompanying drawings.

FIG. 1 is a configuration diagram of an apparatus for controlling a message receiving mode; and

FIG. 2 is a flow chart of a method for controlling a message receiving mode.

### DETAILED DESCRIPTION

The foregoing objects, features and advantages will become more apparent from the following detailed description of exemplary embodiments of the present disclosure with reference to accompanying drawings, which are set forth hereinafter. Accordingly, those having ordinary knowledge in the related art to which the present disclosure pertains will easily embody technical ideas or spirit of the present disclosure. Further, when the detailed description of technologies known in the related art is considered to make the gist of the present disclosure obscure, the detailed description thereof will be omitted. Hereinafter, exemplary embodiments of the present disclosure will be described in detail with reference to the accompanying drawings.

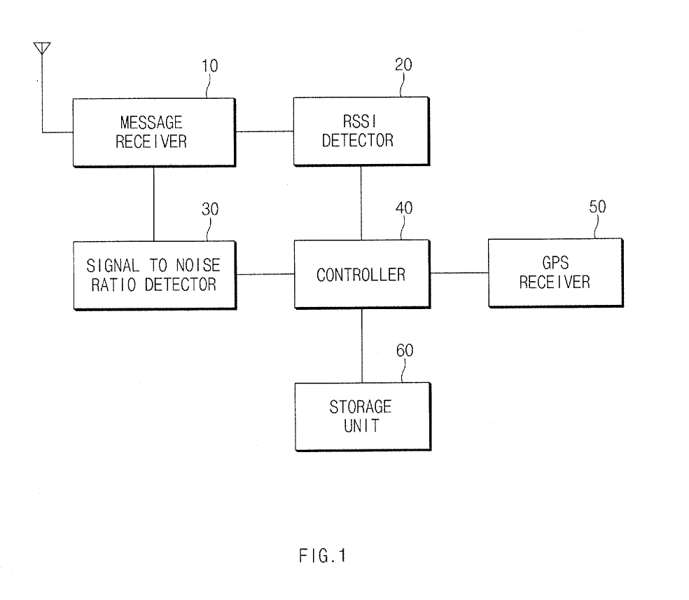

FIG. 1 is a configuration diagram of an apparatus for controlling a message receiving mode.

As illustrated in FIG. 1, the apparatus for controlling a message receiving mode according to the exemplary form of the present disclosure includes a message receiver 10, a received signal strength indicator (RSSI) detector 20, a signal to noise ratio (Ec/Io) detector 30, a controller 40, a GPS receiver 50, and a storage unit 60.

Describing each component, first, the message receiver 10 receives a message to receive various kinds of services from a telematics service center.

Next, the RSSI detector 20 detects the RSSI from the message received by the message receiver 10.

Next, the signal to noise ratio detector 30 detects the signal to noise ratio from the message received by the message receiver 10.

The controller 40 generally controls each component to normally perform its own functions.

In particular, the controller 40 blocks an entry into a sleep mode when the RSSI detected by the RSSI detector 20 is equal to or less than a first threshold value and the signal to noise ratio detected by the signal to noise ratio detector 30 is equal to or less than a second threshold value. Generally, when there is no request from a user or a system, the terminal enters the sleep mode to prevent power from being unnecessarily consumed.

Further, the controller 40 permits an entry into the sleep mode when the RSSI detected by the RSSI detector 20 exceeds the first threshold value and the signal to noise ratio detected by the signal to noise ratio detector 30 exceeds the second threshold value. In this case, a quick paging technology is normally applied.

The quick paging technology is a technology of using a paging indicator bit to reduce the time for which the terminal is unnecessarily woken up, thereby remarkably reducing the power consumption of the terminal in the sleep mode.

Next, as an additional component, the GPS receiver 50 receives position information. In this case, the controller 40 matches the RSSI detected by the RSSI detector 20 and the signal to noise ratio detected by the signal to noise ratio detector 30 with the position information received by the GPS receiver 50 and stores it in the storage unit 60. Here, the position information means position information when a message is received.

Next, the storage unit 60 stores the RSSI and the signal to noise ratio at each position generated by the controller 40, that is, the RSSI and the signal to noise ratio at each section on a driving path. The stored information may be used for various services.

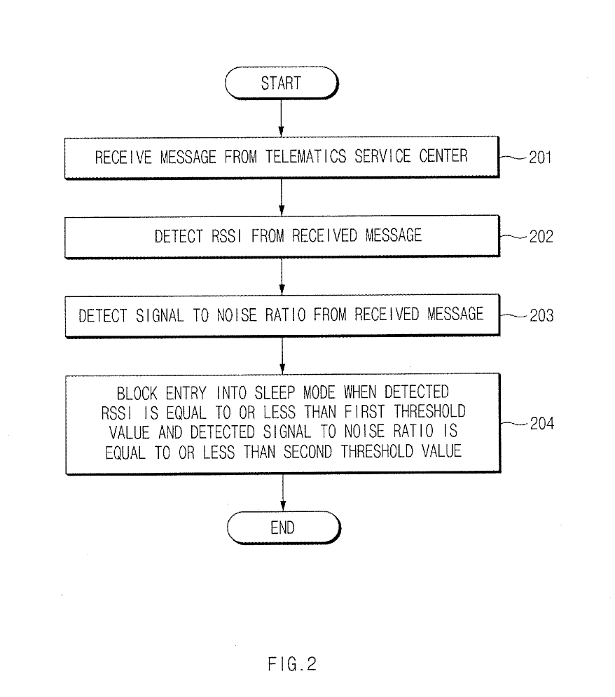

FIG. 2 is a flow chart of a method for controlling a message receiving mode and illustrates a process of controlling a message receiving mode in the telematics terminal to which the quick paging is applied.

First, the message receiver 10 receives the message from the telematics service center (201).

Next, the RSSI detector 20 detects the RSSI from the message received by the message receiver 10 (202).

Further, the signal to noise ratio detector 30 detects the signal to noise ratio from the message received by the message receiver 10 (203).

Next, the controller 40 blocks the entry into the sleep mode when the RSSI detected by the RSSI detector 20 is equal to or less than a first threshold value and the signal to noise ratio detected by the signal to noise ratio detector 30 is equal to or less than a second threshold value (204).

Additionally, the controller 40 matches the RSSI detected by the RSSI detector 20 and the signal to noise ratio detected by the signal to noise ratio detector 30 with the position information received by the GPS receiver 50 and stores it in the storage unit 60.

Further, the present disclosure may further include a transmitter (not illustrated) to transmit the RSSI and the signal to noise ratio at each section on the driving path, which is stored in the storage unit 60, to the telematics service center. In this case, the RSSI and the signal to noise ratio at each section mean an average of the RSSIs at each position within the section and an average of the signal to noise ratios at each position within the section.

As described above, according to the exemplary embodiments of the present disclosure, it is possible to enhance the message receiving rate from the telematics service center even in the weak electric field area, by permitting the entry into the sleep mode when the telematics terminal to which the quick paging system is applied is located in the strong electric field area and blocking the entry into the sleep mode when the telematics terminal is located in the weak electric field area to keep the active mode.

Meanwhile, the method according to the exemplary from of the present disclosure as described above may be prepared by a computer program. Codes and code segments configuring the computer program may be easily deduced by computer programmers in the art. In addition, the prepared computer program is stored in computer readable recording media (information storage media) and is read and executed by computers, thereby implementing the methods according to the present disclosure. Further, the recording media may include any type of recording media which may be read by a computer.

The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. An apparatus for controlling a message receiving mode of a telematics terminal to which quick paging is applied, comprising:
a message receiver configured to receive a message from a telematics service center;
a received signal strength indicator (RSSI) detector configured to detect an RSSI from the message received by the message receiver;
a signal to noise ratio detector configured to detect a signal to noise ratio from the message received by the message receiver; and
a controller configured to block the telematics terminal from entering into a sleep mode when the RSSI detected by the RSSI detector is equal to or less than a first threshold value and the signal to noise ratio detected by the signal to noise ratio detector is equal to or less than a second threshold value.

2. The apparatus according to claim 1, further comprising:
a GPS receiver configured to receive current position information.

3. The apparatus according to claim 2, wherein the controller is further configured to match the RSSI detected by the RSSI detector and the signal to noise ratio detected by the signal to noise ratio detector with position information received by the GPS receiver.

4. The apparatus according to claim 3, further comprising:
a storage unit configured to store the RSSI and the signal to noise ratio at each section on a driving path generated by the controller.

5. A method for controlling a message receiving mode of a telematics terminal to which quick paging is applied, comprising:
receiving, by a message receiver, a message from a telematics service center;
detecting, by an RSSI detector, an RSSI from the received message;
detecting, by a signal to noise ratio detector, a signal to noise ratio from the received message; and
blocking, by a controller, the telematics terminal from entering into a sleep mode when the detected RSSI is equal to or less than a first threshold value and the detected signal to noise ratio is equal to or less than a second threshold value.

6. The method according to claim 5, further comprising:
receiving current position information.

7. The method according to claim 6, further comprising:
matching, by the controller, the detected RSSI and the detected signal to noise ratio with the position information.

8. The method according to claim 7, further comprising:
storing the RSSI and the signal to noise ratio at each section on a driving path generated by the controller.
